(19) United States
(12) Patent Application Publication
(10) Pub. No.: US 2026/0292693 A1
(43) Pub. Date: Sep. 24, 2026

(54) MAIN RADIO WAKING-UP PROCEDURES FOR LOW-POWER WAKE-UP RECEIVER USER EQUIPMENT

(71) Applicant: APPLE INC., Cupertino, CA (US)

(72) Inventors: Jie Cui, San Jose, CA (US); Dan Wu, Beijing (CN); Qiming Li, Beijing (CN); Sigen Ye, San Diego, CA (US); Rolando E. Bettancourt Ortega, Munich (DE); Yang Tang, San Jose, CA (US); Dawei Zhang, Saratoga, CA (US)

(21) Appl. No.: 19/437,516

(22) Filed: Dec. 31, 2025

Related U.S. Application Data
(60) Provisional application No. 63/776,573, filed on Mar. 24, 2025.

(51) Int. Cl. H04W 52/02; H04L 5/00; H04W 52/52; H04W 56/00

(52) U.S. Cl. CPC H04W 52/0235; H04L 5/0048; H04W 52/52; H04W 56/001

(57) ABSTRACT

Systems and methods for main radio (MR) waking-up procedures for low-power wake-up receiver (LP-WUS) user equipment (UE) are discussed. The UE uses a low-power receiver (LR) to monitor for LP-WUSs while an MR of the UE is in a sleep state. In some cases, a UE identifies that a condition for waking the MR from the sleep state has occurred; determines a number of synchronization signal block (SSB) samples to use to perform one or more of automatic gain control (AGC) settling and time/frequency tracking on the MR during an MR waking-up procedure for waking the MR based on the condition; and wakes the MR in response to identifying that the condition for waking the MR from the sleep state has occurred, wherein the waking comprises performing the one or more of the AGC settling and the time/frequency tracking on the MR using the number of SSB samples.

### TECHNICAL FIELD

This application relates generally to wireless communication systems, including wireless communication systems with user equipment (UE) operating with low-power wake-up receivers (LP-WUSs).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for various possible coverage levels in which a UE may be found corresponding to the use of an RRM relaxation mechanism.

FIG. 2 illustrates a method of a UE using an LR to monitor for LP-WUSs while an MR of the UE is in a sleep state, according to embodiments discussed herein.

FIG. 3 illustrates a method of a UE using an LR to monitor for LP-WUSs while an MR of the UE is in a sleep state, according to embodiments discussed herein.

FIG. 4 illustrates a method of a UE using an LR to monitor for LP-WUSs while an MR of the UE is in a sleep state, according to embodiments discussed herein.

FIG. 5 illustrates a method of a UE using an LR to monitor for LP-WUSs while an MR of the UE is in a sleep state, according to embodiments discussed herein.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In various existing wireless communication systems, UEs do not constantly monitor their active carriers during all time units. Rather, UEs are configured to operate in a discontinuous reception (DRX) mode, where the UE periodically wakes up at defined times according to a DRX cycle known to the UE and the network (e.g., once per DRX cycle) in order to check for paging messages from the network that, if present, inform the UE of an upcoming scheduled communication task. If no paging message is present, the UE returns to sleep until the next wake up instance of the DRX cycle.

The power used by the UE to wake up/to check for paging messages according such DRX cycling during instances where there is no signaling or data traffic to schedule between the UE and the network is accordingly “wasted” (e.g., is not used corresponding to any communication that is affirmatively scheduled/occurring between the UE and the base station).

It follows that if the UE were able to wake up only upon being triggered corresponding to actually existing paging, overall power consumption of the UE could be dramatically reduced. This goal can be approached through the use of a low-power wake-up signal (LP-WUS) mechanism. Within such a mechanism, a low-power receiver (LR) of a UE uses relatively low power consumption monitors for an LP-WUS from the network. In some such cases, detection of such an LP-WUS by the LR then triggers the UE to wake a main radio (MR) of the UE (that uses a relatively higher power consumption as compared to the LR) and to use the MR to perform any associated communication with the network. In other such cases, detection of such an LP-WUS that includes an indication to wake the MR (as opposed to, e.g., an LP-WUS including an indication not to wake the MR, or no detection of an LP-WUS at all) by the LR triggers the UE to wake the MR and to use the MR to perform any associated communication with the network.

In other words, it will be understood that the MR of the UE works for data transmission and reception purposes, and can be set to a sleep mode (e.g., powered off and/or set to a low power mode) unless and until it is wakened as triggered corresponding to an LP-WUS reception at the LR of the UE. In this way, power savings can be achieved relative to a case where there is no LR use and an MR (or some radio of the UE with a similar power use profile as an MR) simply always wakes to check for paging according to the applicable DRX cycle.

Various proposals with respect to the use of low-power wake-up receiver (LP-WUR) operation, in particular with respect to MR waking-up aspects, are now summarized. Note that in various places herein, an LP-WUR may be understood the same was as an LR.

Some proposals assert that it is beneficial to define a wake-up delay amount corresponding to a minimum gap time between an LP-WUS reception at an LR and at a time that an MR begins substantive physical downlink control channel (PDCCH) monitoring.

Some proposals call for the use of an “MR activation duration” that defines an interruption time for both a normal case and a worst case (where cell reselection is included in the worst case), where the MR activation duration is understood to include a ramping duration. Under this framework, an MR activation duration may be understood as:

$$Ramping duration + ( 2 + 2 ) samples * SSB\_periodicity ; or$$

$$Ramping duration + ( 2 + 2 + 23 ) samples * SSB\_periodicity + {T}_{SI - NR} + 2 * {T}_{target \_ cell \_ SMTC \_ period} ;$$

where
SSB_periodicity is a synchronization signal block (SSB) periodicity currently under use;
T_{SI-NR} is a system information (SI) broadcasting periodicity; and
T_{target_cell_SMTC_period} is an SSB measurement timing configuration (SMTC) periodicity of a target cell.

Some proposals call for defining that a wake-up time depends on a UE capability (e.g., values of 400 milliseconds (ms) and 800 ms may be proposed for such proposals). Corresponding to such proposals, the use of an “MR sync time” may be proposed with respect to various possible side conditions. A first such side condition may be that in examples where the MR and the LR are well synchronized, LR synchronization information can be reused (e.g., such that the use of one or two SSBs is sufficient). A second such side condition may be that for examples where the MR and the LR are not well synchronized, the MR may apply a more fulsome synchronization procedure (e.g., using at least 10 SSBs).

It may be that, for systems using LP-WUS operation, three candidate values for the wake-up delay capability a UE reports for LP-WUS operation in radio resource control (RRC) IDLE and/or INACTIVE mode are supported.

It may further be that a UE capability report for the wake-up delay supports the indication of one of the three candidate values. Note that in some examples, the candidate values may be 70 ms, 500 ms, and 900 ms.

In such scenarios, it may be that these candidate reported values assume an SSB periodicity of 20 ms. Further, in such scenarios, it may be that the case of 70 ms assumes that three SSBs are needed for synchronization of the MR as part of MR waking, and each of the cases for 500 ms and 900 ms assume that five SSBs are needed for synchronization of the MR as part of MR waking.

The translation of these principles for wake-up delay for different SSB periodicities other than 20 ms, and the potential use of other set(s) of (e.g., 3) candidate values for those different SSB periodicities, may be considered.

A wake-up delay may be understood as a minimum gap time between the reception of an LP-WUS reception at an LR and a time that the MR begins to perform PDCCH monitoring.

In some embodiments for LP-WUS, a low-power synchronization signal (LP-SS) may be used. An LP-SS may be broadcast (e.g., periodically) by the network and received by an LR of a UE. The UE may proceed to perform timing tracking using these LP-SSs on a going-forward basis. This allows the UE to remain synchronized with network broadcasts to its LR. Note that, in various implementations, the LP-SS may not be used to signal the UE to wake its MR.

Aspects with relation to timing tracking periodicity using an LR are now discussed. In some cases, there may exist LP-SS-based radio resource management (RRM) requirements for periodicity and filtering. In some such cases, measurement delay requirements for the use of an LP-WUR that uses LP-SSs when the UE is in an RRC idle or an RRC inactive mode may be defined based on an applicable LP-SS periodicity.

Periodicities for SSB-based LP-WUR measurement delay requirements may also be considered. In such cases, if an LP-SS is not configured for use, periodicities for SSB-based LP-WUR measurement delay requirements may be based on an LP-WUS occasion (LO) periodicity that, in some cases, is understood to match a DRX cycle in use at the UE.

It may be that as between cases where LP-SS is configured for use as to other cases where LP-SS is not configured for use, certain UE behaviors remain the same (e.g., assuming that an LO periodicity is equal to or larger than an LP-SS periodicity).

Aspects with respect to the measurement, at an LR, of LP-SSs in conjunction with further measurements of other synchronization signals for purposes of timing tracking are presently under consideration. Various options under consideration follow.

In a first option, no additional sync signal beyond LP-SS is used, and LP-SS periodicity=320 ms. A first sub-option of this option may be further extended to support LP-SS periodicities of one or more of 80 ms and/or 160 ms (which may be selected according to, e.g., the application of different M values). A second sub-option of this option may not support LP-SS periodicities other than 320 ms.

In a second option, synchronization signals beyond LP-SS may be used, where it is understood that the LP-SS may be transmitted with a given periodicity (e.g., 320 ms). Additional support of other/multiple periodicities may be considered. Various aspects with respect to the selection and configuration of the additional synchronization signal may be considered. Aspects as to whether the additional synchronization signal is configurable and/or conditionally present may be considered.

Taking into account the above framework, it is noted that embodiments herein contemplate various cases, including cases where LP-SSs are used by an LR for timing tracking. In such cases, the transmission of LP-SSs may occur according to a given periodicity, such as 320 ms, 80 ms, and/or 160 ms, etc. Further, it will be understood that in at least some of these cases, additional synchronization signals (e.g., SSBs) may also be used by the LR as part of its timing tracking (in addition to the LP-SSs). Certain embodiments also include cases where SSBs transmitted by the network are used by the LR of a UE for timing tracking when LP-SS use is not configured. In such cases, the SSB tracking periodicity may be same as an LO periodicity used by the UE (which may itself be the same as a DRX cycle periodicity used by the UE).

Embodiments discussed herein relate that, corresponding to each of the above cases for LP-WUS operation at a UE, and no matter which reference signal(s) (e.g., LP-SS and/or SSB) is/are used for timing tracking, a signal measurement (e.g., a signal to interference and noise ratio (SINR), a reference signal received power (RSRP), or a reference signal received quality (RSRQ), etc.) may be considered as part of an MR waking-up procedure. For example, it may be that an LP-WUS may be received to wake up the MR, as has been discussed. However, it may further be that an LR measurement (e.g., an SINR, an RSRP, or an RSRQ) of a serving cell can also trigger the MR to wake up. For example, in a case where the MR is in a fully offloading mode, but the serving cell quality is not good as measured by the LR, the waking-up procedure for the MR may be triggered such that the MR can take a neighbor cell measurement. This and other examples are explained more fully below.

An RRM relaxation mechanism may be used to strategically relax/reduce the amount of cell measurements performed at an MR of the UE in appropriate circumstances such that power savings at the UE are realized. Table 1 includes various possible cases corresponding to the use of MR serving cell measurements and the use of MR neighbor cell measurements under an RRM relaxation mechanism. Note that the LR measurement (of the serving cell) remains active in each possible case.

TABLE 1
Cases for an RRM relaxation mechanism

| RRM measurement | MR serving cell | MR neighboring | LR |
|---|---|---|---|
| case index | measurement | cell measurement | measurement |
| #1 Fully | Off | Off | On |
| offloading case | | | |
| #2 Relaxed case a | On with | Off | On |
| | relaxation | | |
| | measurement | | |
| #3 Relaxed case b | On with | On with | On |
| | relaxation | relaxation | |
| | measurement | measurement | |
| #4 Relaxed case c | Off | On | On |

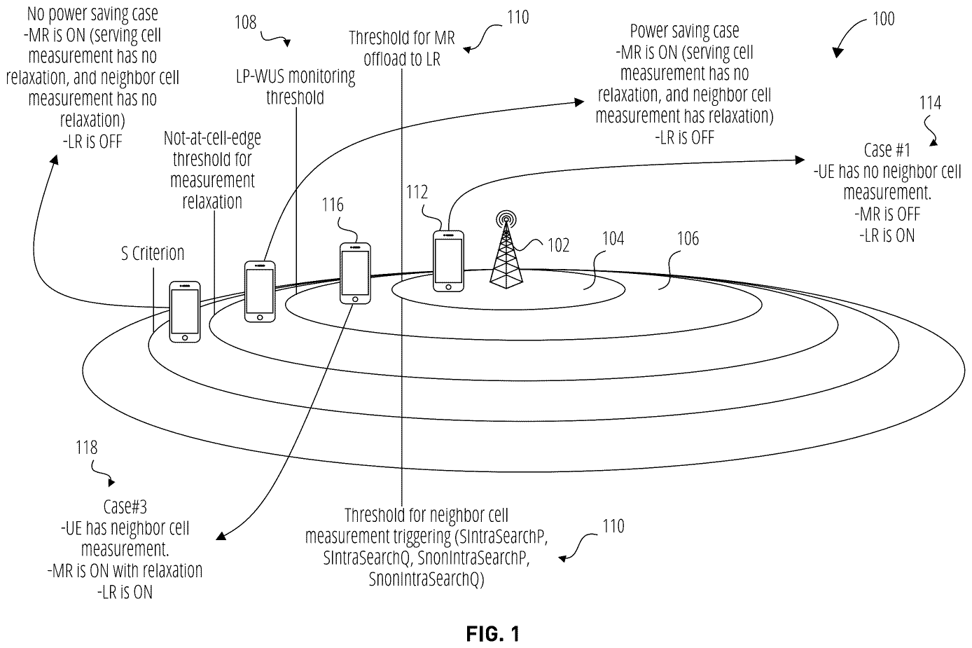

FIG. 1 illustrates a diagram 100 for various possible coverage levels in which a UE may be found corresponding to the use of an RRM relaxation mechanism. The diagram 100 illustrates the concept of coverage quality in terms of proximity to the base station 102. Accordingly, UEs of the diagram 100 that are illustrated as closer to the base station 102 are understood generally to enjoy better coverage by a cell of the base station 102 than UEs of the diagram 100 that are illustrated as relatively further away from the base station 102. Correspondingly, in FIG. 1, various discrete coverage quality levels or intervals are illustrated as expanding circles concentric to the base station 102.

This construct leverages a conceptual shorthand that UE coverage quality can be generally understood to follow UE proximity to the base station 102. However, it should nevertheless be understood that due to various particularized aspects (channel aspects, beamforming aspects, antenna aspects, etc.) it is possible in a real-world deployment for a more-distant UE to be in a better coverage level than a less-distant UE in any individual instance.

Of particular note with respect to LP-WUS mechanism-based embodiments discussed herein are a first coverage level 104 and a second coverage level 106, each of which are within the indicated LP-WUS monitoring threshold 108. The LP-WUS monitoring threshold 108 corresponds to a minimum coverage quality for the activation/use of an LP-WUS mechanism at a UE. In other words, it may be that LP-WUS mechanisms are not used by UEs in coverage levels outside of the LP-WUS monitoring threshold 108.

As illustrated, it is contemplated that the first coverage level 104 may correspond to the operation of a UE 112 that is within the first coverage level 104 according to case #1 114 of the example RRM relaxation mechanism defined above. Corresponding to this operation according to case #1 114, the UE 112 may have an MR that is off/asleep. Accordingly, the UE 112 does not take neighbor cell measurements. Further, the LR remains on, such that LP-WUS monitoring, LR-based serving cell measurement, etcetera is still carried out at the UE 112. The case #1 114 may be understood as a fully offloading mode for the MR of the UE 112.

Further, as also illustrated, it is contemplated that the second coverage level 106 may correspond to the operation of a UE 116 that is within the second coverage level 106 according to case #3 118 of the example RRM relaxation mechanism defined above. Corresponding to operation according to case #3 118, the UE 116 may have an MR that is awake. The MR may be used to take both serving cell measurements and neighbor cell measurements on a relaxed basis (e.g., with a relatively larger periodicity than a periodicity used in a non-relaxed basis case). Further the LR remains on, such that LP-WUS monitoring, LR-based serving cell measurement, etcetera are also carried out at the UE 116.

FIG. 1 illustrates an offloading threshold 110 between the first coverage level 104 and the second coverage level 106. The offloading threshold 110 may represent a point in coverage level for which a UE will change from operating according to the case #1 114 (MR offloading) to operating according to the case #3 118 (without MR offloading), or vice-versa. Accordingly, the offloading threshold 110 may be understood as a point for a coverage level beyond which the UE does or does not operate in a fully offloading mode, and/or at which neighbor cell measurement is or is not used at the UE (as has been illustrated).

As described herein, an LP-WUS can be used to indicate to a UE to receive paging, such that the UE is triggered to wake up its MR for purposes of paging reception. However, corresponding to the discussion of FIG. 1, it is also contemplated that a UE may trigger a waking-up procedure for the MR based on a drop from the first coverage level 104 (and corresponding operation according to the case #1 114) to the second coverage level 106 (and corresponding operation according to the case #3 118) as may be identified based on one or more LR measurements of the serving cell. In other words, corresponding to the discussion of FIG. 1, there exists an LR measurement-based MR waking-up trigger that is due to leaving a fully-offloading mode as a result of a serving cell quality change that indicates that there is, for example, a need to begin taking neighbor cell measurements (which the LR cannot perform).

Various embodiments discussed herein relate to cases where LP-SSs are used by an LR for timing tracking and where the UE may be triggered to wake up the MR either because of an LP-WUS indication or because of a serving cell quality measurement on the LR, as has been discussed. Corresponding to various such cases, the LP-SS may use a given periodicity such as 320 ms, 80 ms, or 160 ms. Corresponding to various such cases, the network may configure the UE to use an additional synchronization signal (besides/in addition to LP-SS) for the LR to use for timing tracking.

Various embodiments discussed herein relate to cases where SSBs are used by the LR for timing tracking when LP-SS use is not configured, and where the UE may be triggered to wake up the MR either because of an LP-WUS indication or because of a serving cell quality measurement on the LR, as has been discussed. Corresponding to some such cases the SSB tracking periodicity is the same as an LO periodicity/DRX cycle. Some such cases may use a serving cell measurement/tracking mechanism where if DRX=320 ms, the UE at least has a chance to track timing every 160 ms. For example, under this serving cell measurement/tracking mechanism, the UE measures a synchronization signal reference signal received power (SS-RSRP) and/or a synchronization signal reference signal received quality (SS-RSRQ) level of the serving cell and evaluates the result according to some cell selection criterion S for the serving cell at least once every M1*N1 DRX cycle; where: M1=2 when an SSB measurement timing configuration (SMTC) periodicity (TSMTC)>20 ms and a DRX cycle≤0.64 seconds; otherwise M1=1.

In such cases, the UE may filter the SS-RSRP and the SS-RSRQ measurements of the serving cell using at least two measurements. Within the set of measurements used for the filtering, at least two measurements may be spaced by at least: eDRX_IDLE cycle/2, if the UE is configured with eDRX cycle≤10.24 seconds; otherwise DRX cycle/2 is used.

No matter the case (e.g., no matter which reference signal(s) is/are used for timing tracking at the LP), embodiments herein contemplate that a reference signal measurement (e.g., SINR, RSRP, or RSRQ) may also be considered for purposes of determining whether to trigger the MR waking-up procedure. For example, it may be that an MR waking-up procedure is triggered because either an LP-WUS is received or because of an LR measurement of the serving cell by the LR (e.g., in a fully offloading case where the LR measures the serving cell quality as not good, as in a change from an operation according to case #1 to a case #3. as discussed elsewhere herein).

Accordingly, in some cases contemplated herein, an LP-WUS triggers an MR wake-up procedure that does not result in neighbor cell measurement. This corresponds to a case where a UE is operating in a fully offloading mode, and where the LP-WUS provides the UE with no reason not to return to the fully offloading mode after receiving the paging indicated by the LP-WUS.

In some cases contemplated herein, an LP-WUS triggers an MR wake-up procedure that does result in a neighbor cell measurement. This corresponds to a case where the UE is initially operating in a fully offloading mode, but upon waking the MR nevertheless leaves the fully offloading mode.

In some cases contemplated herein, the MR wake-up procedure is triggered by an LR measurement of the serving cell. In some such cases, the UE begins to take measurements of the neighbor cell in a relaxed fashion. In some such cases, the UE begins to take measurements of the neighbor cell without relaxation.

Example Embodiments with LP-SS Used by LR for Timing Tracking

If LP-SSs are configured for use by an LR of a UE that is in an RRC IDLE and/or INACTIVE mode for timing tracking purposes, the UE may be triggered to wake up the MR based on various reasons. A first such reason is the reception of an LP-WUS indication for purposes of paging reception, where the UE correspondingly undergoes a wake-up procedure for the MR such that the MR is awake to receive the paging/PDCCH reception.

Another such reason is that the MR of the UE is in a fully offloading mode and is using an LR for serving cell measurement, and the LR measures a metric of the serving cell (e.g., an SINR, an RSRP, or an RSRQ) that is below a corresponding threshold for initializing neighbor cell measurement. The UE correspondingly undergoes a wake-up procedure for the MR such that the MR is able to carry out the neighbor cell measurement (which the LR cannot perform).

In first cases of embodiments where LP-SSs are used by the LR for timing tracking, it may be possible that the LP-SSs occur and/or measured according to a periodicity that is one of a set of possible periodicities (for example, one 320 ms, 80 ms, or 160 ms).

In a first option under the first cases, it may be that the UE implements the use of a different number of SSB samples on the MR for automatic gain control (AGC) settling and/or time/frequency tracking based on the LP-SS periodicity. It may be, for example, that a larger LP-SS periodicity at the LR corresponds to a use of a relatively greater number of SSB samples (or SMTC occasions) on the MR for MR waking-up procedure, while a smaller LP-SS periodicity at the LR corresponds to the use of a relatively fewer number of SSB samples (or SMTC occasion) on the MR for the MR waking-up procedure.

Corresponding to such embodiments, it may be that an MR waking-up procedure time is equal to:

$$MR - ramping - up - time + X \times SSB periodicity ; or to$$

$$MR - ramping - up - time + X \times SMTC periodicity ,$$

MR-ramping-up-time is a ramping duration for the MR;
X is the number of SSB samples;
SSB periodicity is an SSB periodicity of the SSBs sent by the base station; and
SMTC periodicity is an SMTC periodicity used by the UE.

According to this use, it may be that a relatively larger LP-SS periodicity case will correspond to the use of a number of SSB samples X that is greater than (or at least not smaller than) a number of SSB samples X that is used in the case of a relatively smaller LP-SS periodicity case. For example, a value of X used in a case of an LP-SS periodicity of 320 ms may be greater than or equal to a value of X used in a case of an LP-SS periodicity of 160 ms.

In a second option under the first cases, it may be that the UE uses a categorization of LP-SS periodicities into different groups. Then, the UE implements the use of a different number of SSB samples on the MR for AGC settling and/or time/frequency tracking based on the group to which an applicable LP-SS periodicity belongs. Differentiation of the groups may accordingly be understood in terms of certain thresholds for LP-SS periodicity. For example, LP-SS periodicities greater than or equal to 320 ms may be considered as part of a large LP-SS periodicity group, while LP-SS periodicities of less than 320 ms may be considered as part of a small LP-SS periodicity group.

The UE may then use relatively more SSB samples (or SMTC occasions) on the MR for the MR waking-up procedure when an applicable LP-SS periodicity is in the large LP-SS periodicity group and use relatively fewer SSB samples (or SMTC occasions) on the MR for the MR waking-up procedure when an applicable LP-SS periodicity is in the small LP-SS periodicity group.

Corresponding to such embodiments, it may be that an MR waking-up procedure time is equal to

$$MR - ramping - up - time + X \times SSB periodicity ; \\ or to$$

$$MR - ramping - up - time + X \times SMTC periodicity ;$$

where MR-ramping-up-time, SSB periodicity, and SMTC periodicity are as discussed previously herein.

According to this use, an LP-SS periodicity that falls in the larger LP-SS periodicity group will correspond to the use of a number of SSB samples X that is greater than (or at least not smaller than) a number of SSB samples X that is used in the case of an LP-SS periodicity that falls into the smaller LP-SS periodicity group. For example, a value of X used in a case of an LP-SS periodicity of 320 ms that falls into the larger LP-SS periodicity group will be greater than or equal to a value of X used in a case of an LP-SS periodicity of 160 ms that falls into the smaller LP-SS periodicity group.

In second cases of embodiments where LP-SSs are used by LR for timing tracking, it may be possible that additional synchronization signals (in addition to LP-SSs) are configured for use by the LR of the UE for timing tracking purposes.

In a first option for these second cases, it may be that the UE is capable of identifying whether or not additional synchronization signals besides LP-SS is configured for use (or not). Under this option, the UE may implement the use of a different number of SSB samples on the MR for AGC settling and/or time/frequency tracking depending on whether an additional synchronization signal (beyond the LP-SS) is configured for use. When there is no additional synchronization signal configured for use, the UE may use relatively more SSB samples (or SMTC occasions) on the MR for an MR waking-up procedure, while when there is an additional synchronization signal configured for use, the UE may use relatively fewer SSB samples (or SMTC occasions) on the MR for the MR waking-up procedure.

Corresponding to such embodiments, it may be that an MR waking-up procedure time is equal to

$$MR - ramping - up - time + X \times SSB periodicity ; \\ or to$$

$$MR - ramping - up - time + X \times SMTC periodicity ;$$

where MR-ramping-up-time, SSB periodicity, and SMTC periodicity are as discussed previously herein.

According to this use, a case where no additional synchronization signal is configured for use will correspond to the use of a number of SSB samples X that is greater than (or at least not smaller than) a number of SSB samples X that is used in the case where an additional synchronization signal is configured for use.

In a second option for these second cases, the UE may consider together the configuration of the additional synchronization signal and the configuration of the LP-SS in order to determine an effective periodicity to consider. For example, if the additional synchronization signal is configured to occur every 320 ms, and the LP-SS periodicity is also configured to occur every 320 ms, and these two signals are offset by 160 ms, the result would be an effective periodicity (across both types of signals) of 160 ms.

Then, the UE may implement the use of a different number of SSB samples on the MR for automatic gain control (AGC) settling and/or time/frequency tracking based on the effective periodicity. The behavior may track the embodiment described above for the first option under the first cases, with use of the effective periodicity of this second option under the second cases replacing the use of the LP-SS periodicity alone as explained there.

Alternatively, it may be that the UE uses a categorization of effective periodicities into different groups, and where a different number of SSB samples on the MR for AGC settling and/or time/frequency tracking is used based on a group to which an applicable effective periodicity belongs. This behavior may track the embodiment described above for the second option under the first cases, with use of the effective periodicity of this second option under the second cases replacing the use of the LP-SS periodicity alone as explained there.

In a third option for these second cases, the UE may consider a periodicity of the additional synchronization signal as an effective periodicity (and may ignore the LP-SS periodicity).

Then, the UE may implement the use of a different number of SSB samples on the MR for automatic gain control (AGC) settling and/or time/frequency tracking based on the effective periodicity. The behavior may track the embodiment described above for the first option under the first cases, with use of the effective periodicity of this third option under the second cases replacing the use of the LP-SS periodicity alone as explained there.

Alternatively, it may be that the UE uses a categorization of effective periodicities into different groups, and where a different number of SSB samples on the MR for AGC settling and/or time/frequency tracking is used based on a group to which an applicable effective periodicity belongs. This behavior may track the embodiment described above for the second option under the first cases, with use of the effective periodicity of this third option under the second cases replacing the use of the LP-SS periodicity alone as explained there.

In a fourth option for these second cases, the UE may consider a minimum of the LP-SS periodicity and the periodicity of the additional synchronization signal as an effective periodicity (and may ignore the larger of the LP-SS periodicity and the periodicity of the additional synchronization signal).

Then, the UE may implement the use of a different number of SSB samples on the MR for AGC settling and/or time/frequency tracking based on the effective periodicity. The behavior may track the embodiment described above for the first option under the first cases, with use of the effective periodicity of this fourth option under the second cases replacing the use of the LP-SS periodicity alone as explained there.

Alternatively, it may be that the UE uses a categorization of effective periodicities into different groups, and where a different number of SSB samples on the MR for AGC settling and/or time/frequency tracking is used based on a group to which an applicable effective periodicity belongs. This behavior may track the embodiment described above for the second option under the first cases, with use of the effective periodicity of this fourth option under the second cases replacing the use of the LP-SS periodicity alone as explained there.

Example Embodiments when LP-SS is not Configured

In embodiments where LP-SSs are not configured for use by an LR of the UE for timing tracking, it may be understood that the LR instead uses SSBs for timing tracking purposes.

Corresponding to such embodiments, it is contemplated that a UE may be triggered to wake up its MR based on various reasons. A first such reason is the reception of an LP-WUS indication for purposes of paging reception, where the UE correspondingly undergoes a wake-up procedure for the MR such that the MR is awake to handle the indicated paging/PDCCH reception.

Another such reason is that the MR of the UE is in a fully offloading mode and is using the LR for serving cell measurement, and the LR measures a metric of the serving cell (e.g., an SINR, an RSRP, or an RSRQ) that is below a corresponding threshold for initializing neighbor cell measurement. The UE correspondingly undergoes a wake-up procedure for the MR such that the MR is able to carry out the neighbor cell measurement (which the LR cannot perform).

Corresponding to such cases, the SSB tracking periodicity may be the same as an applicable LO periodicity/DRX cycle. Correspondingly, the measurement interval for the current serving cell at the LR may be understood as follows. The UE filters SS-RSRP and SS-RSRQ measurements of the serving cell using at least two measurements. Within the set of measurements used for the filtering, the at least two measurements shall be spaced by at least: eDRX_IDLE cycle/2, if the UE is configured with eDRX cycle≤10.24 seconds; otherwise DRX cycle/2 is used.

In a first option when different DRX cycles or LO periodicities are possible, it may be that UE implements the use of a different number of SSB samples on the MR for AGC settling and/or time/frequency tracking based on the applicable DRX cycle/LO periodicity. It may be, for example, that a larger DRX cycle/LO periodicity at the LR corresponds to a use of a relatively greater number of SSB samples (or SMTC occasions) on the MR for the MR waking-up procedure, while a smaller DRX cycle/LO periodicity at the LR corresponds to the use of a relatively fewer number of SSB samples (or SMTC occasions) on the MR for the MR waking-up procedure.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, it may be that a relatively larger DRX cycle/LO periodicity case will correspond to the use of a number of SSB samples X that is greater than (or at least not smaller than) a number of SSB samples X that is used in the case of a relatively smaller DRX cycle/LO periodicity case. For example, a value of X used in a case of a DRX cycle of 640 ms may be greater than or equal to a value of X used in a case of a DRX cycle of 320 ms.

In a second option when different DRX cycles or LO periodicities are possible, it may be that the UE uses a categorization of DRX cycles/LO periodicities into different groups. The, the UE will implement the use of a different number of SSB samples on the MR for AGC settling and/or time/frequency tracking based on the group to which an applicable DRX cycle/LO periodicity belongs. Differentiation of the groups may accordingly be understood in terms of certain thresholds for DRX cycle/LO periodicity. For example, DRX cycles/LO periodicities greater than 320 ms may be considered as part of a large DRX cycle/LO periodicity group, while DRX cycles/LO periodicities of less than or equal to 320 ms may be considered as part of a small DRX cycle/LO periodicity group.

The UE may then use relatively more SSB samples (or SMTC occasions) on the MR for MR waking-up procedure when an applicable DRX cycle/LO periodicity is in the large DRX cycle/LO periodicity group and use relatively fewer SSB samples (or SMTC occasions) on the MR for MR waking-up procedure when an applicable DRX cycle/LO periodicity is in the small DRX cycle/LO periodicity group.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, a DRX cycle/LO periodicity that falls in the larger DRX cycle/LO periodicity group will correspond to the use of a number of SSB samples X that is greater than (or at least not smaller than) a number of SSB samples X that is used in the case of a DRX cycle/LO periodicity that falls into the smaller DRX cycle/LO periodicity group. For example, e.g., a value of X used in a case of a DRX cycle/LO periodicity of 640 ms that falls into the larger DRX cycle/LO periodicity group will be greater than or equal to a value of X used in a case of a DRX cycle/LO periodicity of 320 ms that falls into the smaller DRX cycle/LO periodicity group.

Example Embodiments when LR Measurement of Serving Cell Signal is Considered

In various embodiments, no matter which reference signal(s) (e.g., LP-SS and/or SSB) is/are used for timing tracking, a signal measurement of the serving cell taken by an LR may be considered as a factor in triggering an MR waking-up procedure at a UE. The signal measurement may be, for example, one of an SINR of the serving cell, an RSRP of the serving cell, and/or an RSRQ of the serving cell.

Corresponding to such embodiments, it may be that reception of an LP-WUS indication for purposes of paging reception may trigger the UE to undergo a wake-up procedure for the MR such that the MR is awake to handle the paging/PDCCH reception.

Additionally or alternatively, it may be that the MR of the UE is in a fully offloading mode and is using its LR to perform serving cell measurements, and the LR measures a serving cell metric (SINR, RSRP, and/or RSRQ) as below a corresponding threshold for using a fully offloading mode. The UE correspondingly undergoes a wake-up procedure for the MR such that the MR is able to carry out the neighbor cell measurement (which the LR cannot perform).

Corresponding to these embodiments, various conditions can be identified.

In a first condition, an LP-WUS received at the LR triggers the MR waking-up procedure at the UE without any neighbor measurements. This corresponds to a case where the serving cell measurement of the LR does not trigger the use of neighbor cell measurements by the MR, where the waking-up procedure for the MR is used only with the goal of using the MR to perform the paging reception indicated by the LP-WUS.

In a second condition, an LP-WUS received at the LR triggers the MR waking-up procedure at the UE and neighbor cell measurements are also ultimately performed by the MR. This corresponds to a case where, for example, both an LP-WUS is received and a reference signal measurement by the LR triggers the UE to perform neighbor cell measurements with the MR after the waking-up procedure.

In a third condition, an LR measurement of the serving cell by the LR triggers the MR waking-up procedure at the UE. For example, it may be that the UE identifies that the LR measurement of the serving cell is below a threshold for using a fully offloading mode, and correspondingly initiates the waking-up for the MR to facilitate neighbor cell measurement by the MR.

Various options that exist for the use of these three conditions by a UE to define its use of an MR waking-up procedure, as will now be explained.

In a first option, it may be that UE implements the use of a different number of SSB samples on the MR for AGC settling and/or time/frequency tracking based on which of the above conditions applies. It may be, for example, that the existence of the third condition corresponds to a use of a number of SSB samples (or SMTC occasions) on the MR for MR waking-up procedure that is greater than or equal to a number of SSB samples (or SMTC occasions) on the MR for MR waking-up procedure that is used when the second condition applies. Further, the existence of the second condition corresponds to a use of a number of SSB samples (or SMTC occasions) on the MR for MR waking-up procedure that is greater than or equal to a number of SSB samples (or SMTC occasions) on the MR for MR waking-up procedure that is used when the first condition applies.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, it may be that the existence of the second condition or the third condition will correspond to the use of a number of SSB samples X that is greater than (or at least not smaller than) a number of SSB samples X that is used in the case of the existence of the first condition.

In a second option, it may be that the UE uses a categorization of the conditions into different groups. Then, the UE implements the use of a different number of SSB samples on the MR for AGC settling and/or time/frequency tracking based on the group to which an existing condition belongs. For example, conditions which trigger a neighbor cell measurement on MR due to a poor serving cell measurement on the LR, such as the second condition and the third condition, may be placed in a first group, while condition 1, which is not associated with a poor serving cell measurement on the LR and thus does not trigger a neighbor cell measurement on the MR, may be placed in a second group.

The UE may then use relatively more SSB samples (or SMTC occasions) on the MR for the MR waking-up procedure when a condition of the first group (associated with the poor serving cell measurement on the LR) is identified, and use relatively fewer SSB samples (or SMTC occasions) on the MR for the MR waking-up procedure when an applicable condition of the second group (not associated with a poor serving cell measurement on the LR) exists.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, existence of a condition associated with the first group (associated with a poor serving cell measurement on the LR) may correspond to the use of a number of SSB samples X that is greater than (or at least not smaller than) a number of SSB samples X that is used in the case that a condition associated with the second group (not associated with a poor serving cell measurement on the LR) exists. For example, a value of X used when a condition associated with the first group exists will be greater than or equal to a value of X used in a case where a condition associated with the second group exists.

In some embodiments, it may be that the UE directly uses the LR measurement of the serving cell (e.g., SINR, RSRP, or RSRQ) to determine a number of SSB samples on the MR to use for AGC settling and/or time/frequency tracking. It may be, for example, that a relatively worse LR measurement of the serving cell corresponds to a use of a relatively greater number of SSB samples (or SMTC occasions) on the MR for MR waking-up procedure, while a relatively better LR measurement of the serving cell corresponds to the use of a relatively fewer number of SSB samples (or SMTC occasion) on the MR for the MR waking-up procedure.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

It is contemplated that for some such embodiments, the UE may use the actual measurement value generated by the LR measurement of the serving cell to determine X.

In other such embodiments, the UE may possess information about ranges of possible measurement values, with different values of X associated to each range. Then, using the LR measurement of the serving cell, the UE may identify a corresponding range (and thus a value of X to use).

Either way, it may be the case that a relatively higher LR measurement/higher representative range corresponds to a use of a relatively lower number of SSB samples X on the MR for AGC settling and/or time/frequency tracking, and that a relatively lower LR measurement/lower representative range corresponds to a use of a relatively larger number of SSB samples X on the MR for AGC settling and/or time/frequency tracking.

Further, corresponding to conditions 2 and 3 discussed above, various sub-conditions may exist.

In a first sub-condition, it may be that the neighbor cell measurement is triggered with relaxation. For example, it may be that the LR measurement of the serving cell is poor enough to trigger the neighbor cell measurement, but is not so poor that it is deemed necessary to avoid the use of relaxation when taking the measurement.

In a second sub-condition, it may be that the neighbor cell measurement is triggered without relaxation. For example, it may be that the LR measurement of the serving cell is poor enough to both trigger the neighbor cell measurement and to cause the UE to avoid the use of relaxation when taking the neighbor cell measurement.

When these sub-conditions are in use, it may be that the existence of the second sub-condition leads to the use of relatively more SSB samples on the MR for AGC settling and/or time/frequency tracking, while the existence of the first sub-condition leads to the use of relatively fewer SSB samples on the MR for AGC settling and/or time/frequency tracking.

Note that in some case where the trigger to initiate the waking-up procedure for the MR is the reception of an LP-WUS, a number of SSB samples on the MR for AGC settling and/or time/frequency tracking may vary based on where an LR measurement of the serving cell falls within an RRM relaxation mechanism. For example, the number of SSB samples may vary based on whether this measurement is above an offloading threshold (e.g., the offloading threshold 110 discussed in relation to FIG. 1) such that the UE operates according to a first coverage level (e.g., corresponding to operation according to the case #1 114 discussed in relation to FIG. 1) or whether this measurement is below the offloading threshold such that the UE operates according to a second, lower coverage level (e.g., corresponding to operation according to the case #3 118 discussed in relation to FIG. 1).

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, when the reception of an LP-WUS triggers the UE to perform a waking-up procedure on the MR in order to receive paging, if the serving cell measurement by the LR (e.g., RSRP measurement, RSRQ measurement) meets the offloading threshold used by the RRM relaxation mechanism, the UE may use a relatively fewer number of SSB samples X for the MR waking-up procedure. Alternatively, if the serving cell measurement by the LR does not meet the offloading threshold used by the RRM relaxation mechanism, the UE may use a relatively fewer number of SSB samples X for the MR waking-up procedure.

Corresponding to this example, it is thus seen that a total delay for the MR waking-up procedure time when the offloading threshold it met is less than the total delay for the MR waking-up procedure when the offloading threshold is not met.

Note that in cases where SSB-based measuring/tracking is used by UE (e.g., where the UE uses an orthogonal frequency division multiplexing (OFDM)-based receiver of the LR to measure and track SSBs), and where such operation follows LO periodicity/DRX cycle, it may be that the LO periodicity (Y) is greater than a predefined time threshold (e.g., as may be provided for in a specification of the wireless communication system). For example, it may be that Y=2.56 seconds, while a predefined time threshold that is used (e.g., per specification) is 2400 ms.

Corresponding to such embodiments, it may be that an MR waking-up procedure time is equal to

$$MR - ramping - up - time + X \times SSB periodicity ;$$

$$or to$$

$$MR - ramping - up - time + X \times SMTC periodicity ;$$

where MR-ramping-up-time, SSB periodicity, and SMTC periodicity are as discussed previously herein.

According to this use, in cases where Y is greater than the threshold, it may be that the UE uses a relatively larger number of SSB samples X for the MR waking-up procedure than a number of SSB samples X for the MR waking-up procedure that is used in alternative cases where Y is not greater than the threshold. For example, assuming an applicable time threshold of 2400 ms, a number of SSB samples X used when Y=2.56 seconds may be greater than a number of SSB samples X used when Y=1.28 seconds, 0.64 seconds, or 0.32 seconds. Corresponding to this example, it is thus seen that a total delay for the MR waking-up procedure time when Y=2.56 seconds will be longer than for values of Y=1.28 seconds, 0.64 seconds, or 0.32 seconds

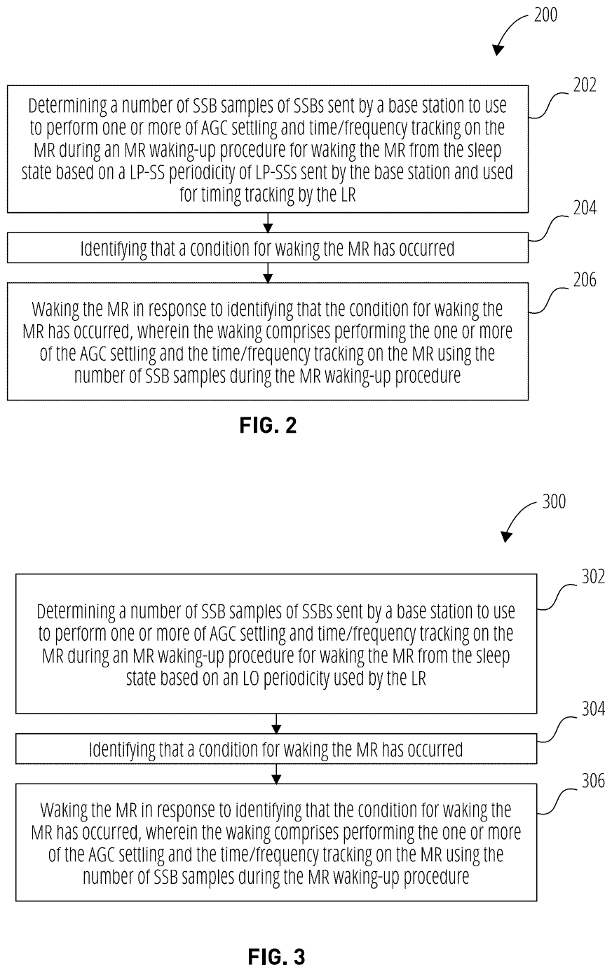

FIG. 2 illustrates a method 200 of a UE using an LR to monitor for LP-WUSs while an MR of the UE is in a sleep state, according to embodiments discussed herein. The method 200 includes determining 202 a number of SSB samples of SSBs sent by a base station to use to perform one or more of AGC settling and time/frequency tracking on the MR during an MR waking-up procedure for waking the MR from the sleep state based on an LP-SS periodicity of LP-SSs sent by the base station and used for timing tracking by the LR. The method 200 further includes identifying 204 that a condition for waking the MR has occurred. The method 200 further includes waking 206 the MR in response to identifying that the condition for waking the MR has occurred, wherein the waking comprises performing the one or more of the AGC settling and the time/frequency tracking on the MR using the number of SSB samples during the MR waking-up procedure.

In some embodiments of the method 200, the number of SSB samples is determined according to a positive correlation between the LP-SS periodicity and the number of SSB samples.

In some embodiments, the method 200 further includes identifying an LP-SS periodicity group corresponding to the LP-SS periodicity; wherein the number of SSB samples is determined according to the identified LP-SS periodicity group for the LP-SS periodicity.

In some embodiments of the method 200, the LR further uses second synchronization signals of a second synchronization signal type that are sent by the base station for the timing tracking; and wherein the number of SSB samples is determined further based on the use by the LR of the second synchronization signals for the timing tracking. In some such embodiments, the method 200 further includes determining an effective periodicity for a joint use of both the LP-SSs and the second synchronization signals; wherein the number of SSB samples is determined based on the effective periodicity. In some such embodiments, the method 200 further includes determining an effective periodicity based on a minimum of the LP-SS periodicity and a second periodicity of the second synchronization signals; wherein the number of SSB samples is determined based on the effective periodicity.

In some embodiments, the method 200 further includes determining a duration of the MR waking-up procedure according to:

$$MR - ramping - up - time + X \times SSB periodicity ,$$

MR-ramping-up-time is a ramping duration for the MR;
SSB periodicity is an SSB periodicity of the SSBs sent by the base station; and
X is the number of SSB samples.

FIG. 3 illustrates a method 300 of a UE using an LR to monitor for LP-WUSs while an MR of the UE is in a sleep state, according to embodiments discussed herein. The method 300 includes determining 302 a number of SSB samples of SSBs sent by a base station to use to perform one or more of AGC settling and time/frequency tracking on the MR during an MR waking-up procedure for waking the MR from the sleep state based on an LO periodicity used by the LR. The method 300 further includes identifying 304 that a condition for waking the MR has occurred. The method 300 further includes waking 306 the MR in response to identifying that the condition for waking the MR has occurred, wherein the waking comprises performing the one or more of the AGC settling and the time/frequency tracking on the MR using the number of SSB samples during the MR waking-up procedure.

In some embodiments of the method 300, the number of SSB samples is determined according to a positive correlation between the LO periodicity and the number of SSB samples.

In some embodiments, the method 300 further includes identifying an LO periodicity group corresponding to the LO periodicity; wherein the number of SSB samples is determined according to the identified LO periodicity group for the LO periodicity.

In some embodiments, the method 300 further includes determining a duration of the MR waking-up procedure according to:

$$MR - ramping - up - time + X \times SSB periodicity ,$$

MR-ramping-up-time is a ramping duration for the MR;
SSB periodicity is an SSB periodicity of SSBs sent by the base station; and
X is the number of SSB samples.

In some embodiments of the method 300, when the LR uses the SSBs for timing tracking, the number of SSB samples is determined based on a comparison of the LO periodicity to a time threshold.

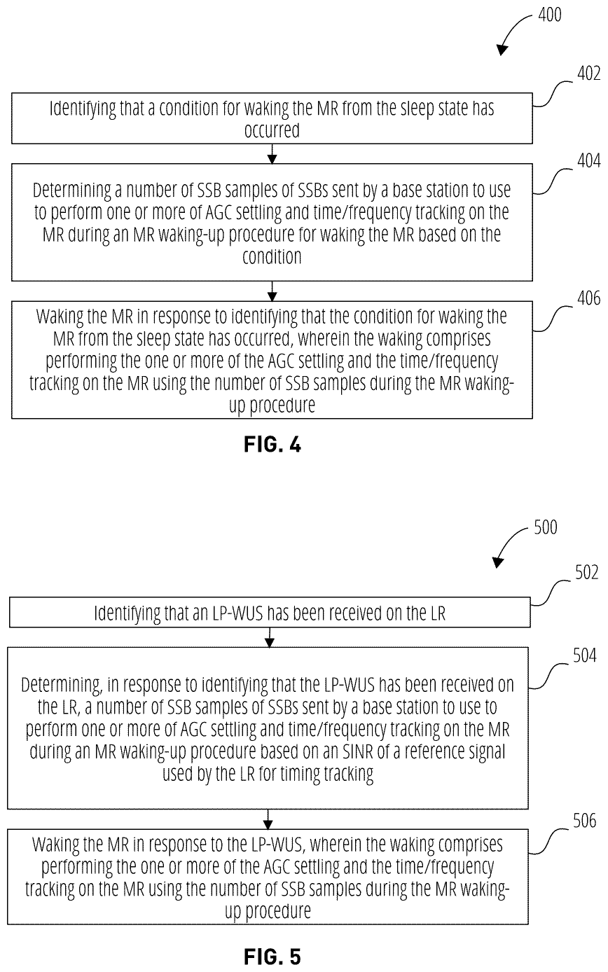

FIG. 4 illustrates a method 400 of a UE using an LR to monitor for LP-WUSs while an MR of the UE is in a sleep state, according to embodiments discussed herein. The method 400 includes identifying 402 that a condition for waking the MR from the sleep state has occurred. The method 400 further includes determining 404 a number of SSB samples of SSBs sent by a base station to use to perform one or more of AGC settling and time/frequency tracking on the MR during an MR waking-up procedure for waking the MR based on the condition. The method 400 further includes waking 406 the MR in response to identifying that the condition for waking the MR from the sleep state has occurred, wherein the waking comprises performing the one or more of the AGC settling and the time/frequency tracking on the MR using the number of SSB samples during the MR waking-up procedure.

In some embodiments, the method 400 further includes identifying a condition group corresponding to the condition; wherein the number of SSB samples is determined according to the identified condition group for the condition.

In some embodiments of the method 400, when the condition comprises that a reference signal measurement of a reference signal used by the LR for timing tracking does not meet the threshold, the number of SSB samples is determined to be of a first value; and when the condition does not comprise that the SINR of the reference signal used for the timing tracking by the LR meets the threshold, the number of SSB samples is determined to be of a second value that is less than the first value. In some such embodiments, the reference signal measurement is one of an SINR, an RSRP, and an RSRQ.

In some embodiments of the method 400, the condition comprises a determination that a reference signal measurement of a reference signal used by the LR for timing tracking does not meet a first threshold. In some such embodiments, the method 400 further includes determining that the reference signal measurement is above a second threshold for using relaxed neighbor cell measurements; and performing the relaxed neighbor cell measurements using the MR after waking the MR. In some such embodiments, the method 400 further includes determining that the reference signal measurement does not meet a second threshold of using relaxed neighbor cell measurements; and performing neighbor cell measurements that are not relaxed according to the relaxed neighbor cell measurements using the MR after waking the MR. In some such embodiments, the reference signal measurement is one of an SINR, an RSRP, and an RSRQ.

In some embodiments, the method 400 further includes determining a duration of the MR waking-up procedure according to:

$$MR - ramping - up - time + X \times SSB periodicity ,$$

MR-ramping-up-time is a ramping duration for the MR;
SSB periodicity is an SSB periodicity of SSBs sent by the base station; and
X is the number of SSB samples.

FIG. 5 illustrates a method 500 of a UE using an LR to monitor for LP-WUSs while an MR of the UE is in a sleep state, according to embodiments discussed herein. The method 500 includes identifying 502 that an LP-WUS has been received on the LR. The method 500 further includes determining 504, in response to identifying that the LP-WUS has been received on the LR, a number of SSB samples of SSBs sent by a base station to use to perform one or more of AGC settling and time/frequency tracking on the MR during an MR waking-up procedure based on an SINR of a reference signal used by the LR for timing tracking. The method 500 further includes waking 506 the MR in response to the LP-WUS, wherein the waking comprises performing the one or more of the AGC settling and the time/frequency tracking on the MR using the number of SSB samples during the MR waking-up procedure.

In some embodiments of the method 500, when the SINR of the reference signal used by the LR for the timing tracking does not meet a threshold, the number of SSB samples is determined to be of a first value; and when the SINR of the reference signal used for the timing tracking by the LR meets the threshold, the number of SSB samples is determined to be of a second value that is less than the first value.

In some embodiments, the method 500 further includes determining a duration of the MR waking-up procedure according to:

$$MR - ramping - up - time + X \times SSB periodicity ,$$

where:
MR-ramping-up-time is a ramping duration for the MR;
SSB periodicity is an SSB periodicity of SSBs sent by the base station; and
X is the number of SSB samples.

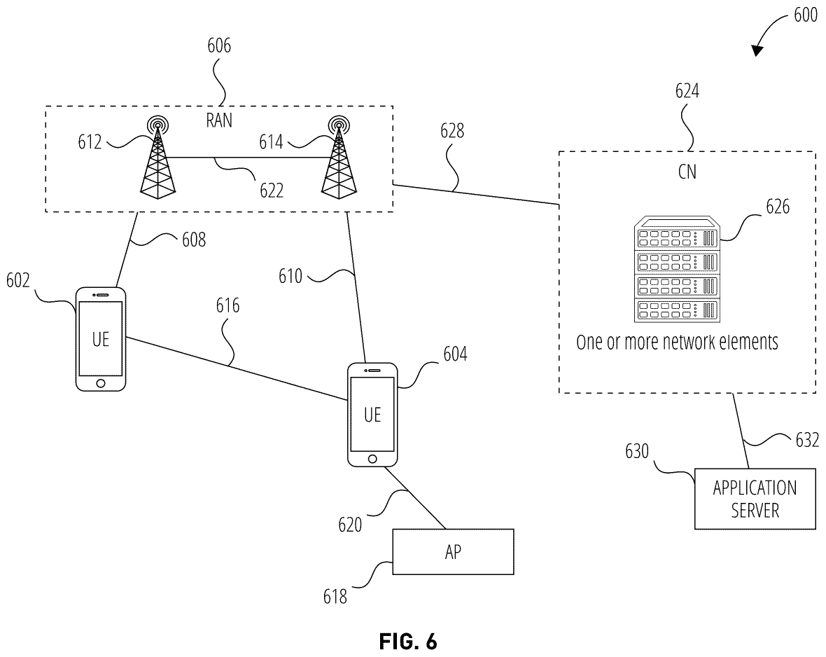

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations (such as base station 612 and base station 614) that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

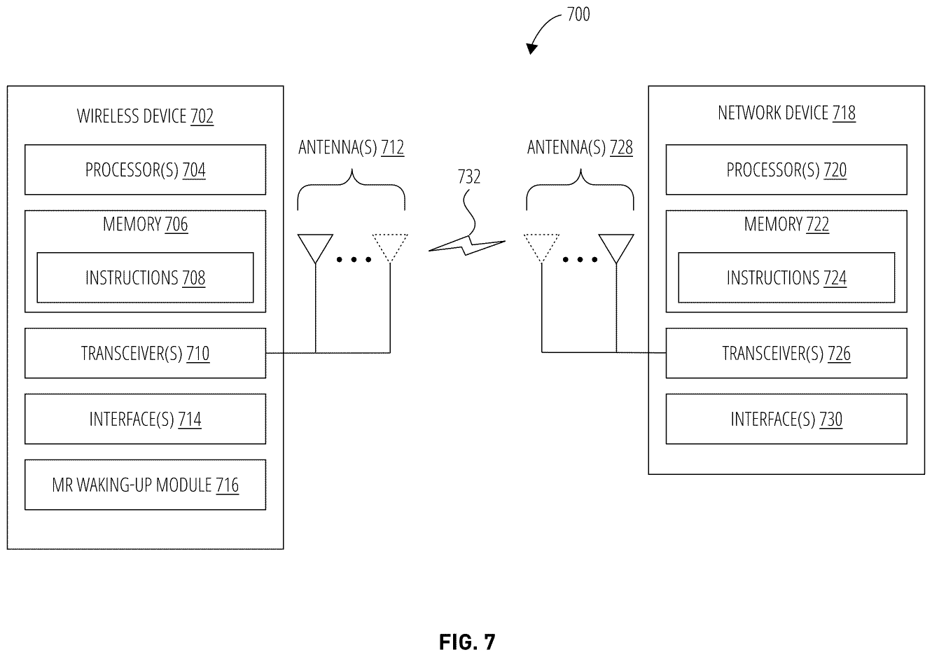

FIG. 7 illustrates a system 700 for performing signaling 732 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter circuitry and/or receiver circuitry that use the antenna(s) 712 of the wireless device 702 to facilitate signaling (e.g., the signaling 732) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth® and the like).

The wireless device 702 may include an MR waking-up module 716. The MR waking-up module 716 may be implemented via hardware, software, or combinations thereof. For example, the MR waking-up module 716 may be implemented as a processor, circuit, and/or instructions 708 stored in the memory 706 and executed by the processor(s) 704. In some examples, the MR waking-up module 716 may be integrated within the processor(s) 704 and/or the transceiver(s) 710. For example, the MR waking-up module 716 may be implemented by a combination of software components (e.g., executed by a DSP or a general processor) and hardware components (e.g., logic gates and circuitry) within the processor(s) 704 or the transceiver(s) 710.

The MR waking-up module 716 may be used for various aspects of the present disclosure, for example, aspects of FIG. 2, FIG. 3, FIG. 4, and/or FIG. 5. For example, the MR waking-up module 716 may configure the wireless device 702 to determine a number of SSB samples of SSBs sent by a base station to use to perform one or more of AGC settling and time/frequency tracking on an MR during an MR waking-up procedure for waking the MR from a sleep state based on an LP-SS periodicity of LP-SSs sent by the base station and used for timing tracking by the LR; identify that a condition for waking the MR has occurred, and wake the MR in response to identifying that the condition for waking the MR has occurred, wherein the waking comprises performing the one or more of the AGC settling and the time/frequency tracking on the MR using the number of SSB samples during the MR waking-up procedure. As another example, the MR waking-up module 716 may configure the wireless device 702 to determine a number of SSB samples of SSBs sent by a base station to use to perform one or more of AGC settling and time/frequency tracking on an MR during an MR waking-up procedure for waking the MR from the sleep state based on an LO periodicity used by the LR; identify that a condition for waking the MR has occurred; and wake the MR in response to identifying that the condition for waking the MR has occurred, wherein the waking comprises performing the one or more of the AGC settling and the time/frequency tracking on the MR using the number of SSB samples during the MR waking-up procedure. As another example, the MR waking-up module 716 may configure the wireless device 702 to identify that a condition for waking the MR from the sleep state has occurred; determine a number of SSB samples of SSBs sent by a base station to use to perform one or more of AGC settling and time/frequency tracking on an MR during an MR waking-up procedure for waking the MR based on the condition; and wake the MR in response to identifying that the condition for waking the MR from the sleep state has occurred, wherein the waking comprises performing the one or more of the AGC settling and the time/frequency tracking on the MR using the number of SSB samples during the MR waking-up procedure. As another example, the MR waking-up module 716 may configure the wireless device 702 to identify that an LP-WUS has been received on an LR; determine, in response to identifying that the LP-WUS has been received on the LR, a number of SSB samples of SSBs sent by a base station to use to perform one or more of AGC settling and time/frequency tracking on the MR during an MR waking-up procedure based on an SINR of a reference signal used by the LR for timing tracking; and wake the MR in response to the LP-WUS, wherein the waking comprises performing the one or more of the AGC settling and the time/frequency tracking on the MR using the number of SSB samples during the MR waking-up procedure.

The network device 718 may include one or more processor(s) 720. The processor(s) 720 may execute instructions such that various operations of the network device 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter circuitry and/or receiver circuitry that use the antenna(s) 728 of the network device 718 to facilitate signaling (e.g., the signaling 732) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

Embodiments contemplated herein include an apparatus comprising means to perform one or more elements of any of the method 200, the method 300, the method 400, and/or the method 500. This apparatus may be, for example, an apparatus of a UE (such as a wireless device 702 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 200, the method 300, the method 400, and/or the method 500 This non-transitory computer-readable media may be, for example, a memory of a UE (such as a memory 706 of a wireless device 702 that is a UE, as described herein).

Embodiments contemplated herein include an apparatus comprising logic, modules, or circuitry to perform one or more elements of any of the method 200, the method 300, the method 400, and/or the method 500. This apparatus may be, for example, an apparatus of a UE (such as a wireless device 702 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 200, the method 300, the method 400, and/or the method 500. This apparatus may be, for example, an apparatus of a UE (such as a wireless device 702 that is a UE, as described herein).

Embodiments contemplated herein include a signal as described in or related to one or more elements of any of the method 200, the method 300, the method 400, and/or the method 500.

Embodiments contemplated herein include a computer program or computer program product comprising instructions, wherein execution of the program by a processor is to cause the processor to carry out one or more elements of any of the method 200, the method 300, the method 400, and/or the method 500. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) using a low-power receiver (LR) to monitor for low-power wake-up signals (LP-WUSs) while a main radio (MR) of the UE is in a sleep state, comprising:
determining a number of synchronization signal block (SSB) samples of SSBs sent by a base station to use to perform one or more of automatic gain control (AGC) settling and time/frequency tracking on the MR during an MR waking-up procedure for waking the MR from the sleep state based on a low-power synchronization signal (LP-SS) periodicity of LP-SSs sent by the base station and used for timing tracking by the LR;
identifying that a condition for waking the MR has occurred; and
waking the MR in response to identifying that the condition for waking the MR has occurred, wherein the waking comprises performing the one or more of the AGC settling and the time/frequency tracking on the MR using the number of SSB samples during the MR waking-up procedure.

2. The method of claim 1, wherein the number of SSB samples is determined according to a positive correlation between the LP-SS periodicity and the number of SSB samples.

3. The method of claim 1, further comprising identifying an LP-SS periodicity group corresponding to the LP-SS periodicity; and wherein the number of SSB samples is determined according to the identified LP-SS periodicity group for the LP-SS periodicity.

4. The method of claim 1, wherein the LR further uses second synchronization signals of a second synchronization signal type that are sent by the base station for the timing tracking; and wherein the number of SSB samples is determined further based on the use by the LR of the second synchronization signals for the timing tracking.

5. The method of claim 4, further comprising determining an effective periodicity for a joint use of both the LP-SSs and the second synchronization signals; and wherein the number of SSB samples is determined based on the effective periodicity.

6. The method of claim 4, further comprising determining an effective periodicity based on a minimum of the LP-SS periodicity and a second periodicity of the second synchronization signals; and wherein the number of SSB samples is determined based on the effective periodicity.

7. The method of claim 1, further comprising determining a duration of the MR waking-up procedure according to:
$$MR - ramping - up - time + X \times SSB periodicity ,$$
MR-ramping-up-time is a ramping duration for the MR;
SSB periodicity is an SSB periodicity of the SSBs sent by the base station; and
X is the number of SSB samples.

8. A method of a user equipment (UE) using a low-power receiver (LR) to monitor for low-power wake-up signals (LP-WUSs) while a main radio (MR) of the UE is in a sleep state, comprising:
determining a number of synchronization signal block (SSB) samples of SSBs sent by a base station to use to perform one or more of automatic gain control (AGC) settling and time/frequency tracking on the MR during an MR waking-up procedure for waking the MR from the sleep state based on a LP-WUS occasion (LO) periodicity used by the LR;
identifying that a condition for waking the MR has occurred; and
waking the MR in response to identifying that the condition for waking the MR has occurred, wherein the waking comprises performing the one or more of the AGC settling and the time/frequency tracking on the MR using the number of SSB samples during the MR waking-up procedure.

9. The method of claim 8, wherein the number of SSB samples is determined according to a positive correlation between the LO periodicity and the number of SSB samples.

10. The method of claim 8, further comprising identifying an LO periodicity group corresponding to the LO periodicity; and wherein the number of SSB samples is determined according to the identified LO periodicity group for the LO periodicity.

11. The method of claim 8, further comprising determining a duration of the MR waking-up procedure according to:
$$MR - ramping - up - time + X \times SSB periodicity ,$$
where:
MR-ramping-up-time is a ramping duration for the MR;
SSB periodicity is an SSB periodicity of SSBs sent by the base station; and
X is the number of SSB samples.

12. The method of claim 8, wherein when the LR uses the SSBs for timing tracking, the number of SSB samples is determined based on a comparison of the LO periodicity to a time threshold.

13. A method of a user equipment (UE) using a low-power receiver (LR) to monitor for low-power wake-up signals (LP-WUSs) while a main radio (MR) of the UE is in a sleep state, comprising:
identifying that a condition for waking the MR from the sleep state has occurred;
determining a number of synchronization signal block (SSB) samples of SSBs sent by a base station to use to perform one or more of automatic gain control (AGC) settling and time/frequency tracking on the MR during an MR waking-up procedure for waking the MR based on the condition; and
waking the MR in response to identifying that the condition for waking the MR from the sleep state has occurred, wherein the waking comprises performing the one or more of the AGC settling and the time/frequency tracking on the MR using the number of SSB samples during the MR waking-up procedure.

14. The method of claim 13, further comprising identifying a condition group corresponding to the condition; and wherein the number of SSB samples is determined according to the identified condition group for the condition.

15. The method of claim 13, wherein:
when the condition comprises that a reference signal measurement of a reference signal used by the LR for timing tracking does not meet threshold, the number of SSB samples is determined to be of a first value; and
when the condition does not comprise that the SINR of the reference signal used for the timing tracking by the LR meets the threshold, the number of SSB samples is determined to be of a second value that is less than the first value.

16. The method of claim 15, wherein the reference signal measurement is one of a signal to interference and noise ratio (SINR), a reference signal received power (RSRP), and a reference signal received quality (RSRQ).

17. The method of claim 13, wherein the condition comprises a determination that reference signal measurement of a reference signal used by the LR for timing tracking does not meet a first threshold.

18. The method of claim 17, further comprising:
determining that the reference signal measurement is above a second threshold for using relaxed neighbor cell measurements; and
performing the relaxed neighbor cell measurements using the MR after waking the MR.

19. The method of claim 17, further comprising:
determining that the reference signal measurement does not meet a second threshold of using relaxed neighbor cell measurements; and
performing neighbor cell measurements that are not relaxed according to the relaxed neighbor cell measurements using the MR after waking the MR.

20. The method of claim 17, wherein the reference signal measurement is one of a signal to interference and noise ratio (SINR), a reference signal received power (RSRP), and a reference signal received quality (RSRQ).
